(19) United States
(12) Patent Application Publication
(10) Pub. No.: US 2005/0248124 A1
(43) Pub. Date: Nov. 10, 2005

(54) Fifth wheel hitch

(76) Inventors: Sean Phillips, Huntsville, Ontario (CA); Michael Valliere, Huntville (CA)

Correspondence Address: Todd A Benni;McDonald Hopkins Company, Suite 2100, 600 Superior Avenue E, Cleveland, OH, 44114, US

(21) Appl. No.: 10/536,575

(22) PCT Filed: Dec. 2, 2003
(86) PCT No.: PCT/US03/38038

§ 371 Date: May 26, 2005

(30) Foreign Application Priority Data
Dec. 2, 2002 (US) 60430310

(51) Int. Cl. B60D 1/00

(52) U.S. Cl. 280/477

(57) ABSTRACT

An adjustable fifth wheel hitch for towing a trailer behind a motor vehicle includes a support frame having a pair of spaced guide rails. A head assembly for engaging the trailer is coupled to the support frame through an adjustment assembly so as to be selectively displaceable between a towing position and a maneuvering position. A locking assembly releasably locks the head assembly in the towing and maneuvering positions. The locking assembly includes a locking arm positionable in a locked position, which is engaged with one of the pair of spaced guide rails, and an unlocked position. The locking arm includes a camming surface that cooperates with a locking cam so as to position the locking arm in the locked position and the unlocked position.

### FIELD OF THE INVENTION

The present invention generally relates to trailer hitches and, more particularly, to an adjustable fifth wheel hitch capable of selectively providing enhanced maneuverability in limited or tight operating areas.

### BACKGROUND OF THE INVENTION

As is well known, fifth wheel hitches are often used for towing a trailer behind a vehicle. Conventional fifth wheel hitches typically include a support frame for mounting the hitch to the towing vehicle, such as, for example, to a bed of a pickup truck. This support frame includes a pair of base rails that are bolted to the bed and/or frame of the truck, side brackets that are releasably mounted to the base rails and a head support mounted to the side brackets. A head assembly is mounted to the head support by means of a trunnion arrangement allowing for pivotal fore-and-aft movement. The head assembly includes a jaw assembly operable by means of a control handle. The jaw assembly is specifically adapted to releasably engage and hold a kingpin of a trailer desired to be towed by the vehicle.

Conventional fifth wheel trailer hitches typically limit the maneuverability of a towing vehicle at low speeds and in close quarters. In particular, fifth wheel hitches typically center the kingpin of the trailer substantially between the rear wheels and over the rear axle of the towing vehicle. When so mounted, very close clearance is provided between the trailer and portions of the towing vehicle. Under normal towing conditions, the close clearance is sufficient to allow effective operation under speed on the open road. However, the close clearance may hinder maneuverability, especially in situations requiring tight cornering within limited space, such as, for example, the conditions found at campgrounds and some trailer parks.

In order to address the disadvantage in maneuvering a trailer using a conventional fifth wheel trailer hitches, various attempts at adjustable fifth wheel hitches have been made. It has been found that by temporarily moving the hitch assembly rearward in the towing vehicle, clearance between the towing vehicle and the trailer is increased, thereby allowing for greater maneuverability of the trailer. In one adjustable fifth wheel hitch design, the trailer must be detached from the fifth wheel hitch prior to any adjustment of the fifth wheel hitch. The detachment efforts are time consuming and require precise movement of the towing vehicle. The adjustable hitches also typically require more than one person to effect the adjustment of the fifth wheel hitch. Another design utilizes low friction shoes within upright mounting members for movement on parallel guide rails. The uprights are selectively slidable along each guide rail. Each upright includes a hollow cavity for receiving a dual bar latch and a leaf spring for biasing the dual bar latch into a position to lock the uprights against slidable movement. However, the effective weight borne by the low friction shoes tends to cause binding of the shoes such that seizing may occur. The high friction between moving parts prevents easy and smooth adjustment of the fifth wheel trailer hitch. Moreover, the latching mechanism is hidden from view, thereby preventing an operator from confirming engagement of the locking mechanism to lock the adjustable portion against slidable movement.

Accordingly, there exists a need in the relevant art to provide an adjustable fifth wheel hitch that is capable of moving the hitch assembly rearward in the towing vehicle to increase the clearance between the towing vehicle and the trailer to allow greater maneuverability of the trailer. Furthermore, there exists a need in the relevant art to provide an adjustable fifth wheel hitch that is capable of overcoming the disadvantages of the prior art.

### SUMMARY OF THE INVENTION

According to the principles of the present invention, an adjustable fifth wheel hitch for towing a trailer behind a vehicle is provided having an advantageous construction. The fifth wheel hitch includes a support frame having a pair of spaced guide rails. A head assembly for engaging the trailer is coupled to the support frame through an adjustment assembly to be selectively displaceable between a towing position and a maneuvering position. A locking assembly releasably locks the head assembly in the towing and maneuvering positions. The locking assembly includes a locking arm positionable in a locked position, which is engaged with one of the pair of spaced guide rails, and an unlocked position. The locking arm includes a camming surface that cooperates with a locking cam to position the locking arm in the locked position and the unlocked position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view illustrating a fifth wheel hitch according to the principles of the present invention;

FIG. 2 is an enlarged perspective view illustrating an adjustment assembly;

FIG. 3 is a plan view illustrating the adjustment assembly;

FIG. 4 is a side view illustrating the adjustment assembly;

FIG. 5 is an end view illustrating the adjustment assembly;

FIG. 6 is an exploded perspective view illustrating the adjustment assembly and locking assembly;

FIG. 7 is a side view illustrating the adjustment assembly and locking assembly, with portions removed for clarity, in a locked towing position;

FIG. 8 is a side view illustrating the adjustment assembly in a locked towing position;

FIG. 9 is a side view illustrating the adjustment assembly in a locked maneuvering position; and

FIG. 10 is an enlarged perspective view illustrating the locking arm retaining device.

### DETAILED DESCRIPTION OF THE PREFERRED EMBODIMENTS

The following description of the preferred embodiment is merely exemplary in nature and is in no way intended to limit the invention, its application, or uses.

With particular reference to the figures, a fifth wheel hitch 10 is provided according to the principles of the present invention. Fifth wheel hitch 10 includes a support frame 12 having a pair of spaced-apart, parallel base rails 14 of conventional design. Base rails 14 are bolted or otherwise fastened to the frame of the motor vehicle in a manner well known in the art. Support frame 12 further includes a pair of spaced guide rails 16 that are mounted to bridge between the transversely extending base rails 14 and thereby extend parallel to the longitudinal axis of the motor vehicle. Each guide rail 16 is formed from a round or generally oblong tubular member constructed from steel or other appropriate high strength material. An end cap 18 may be welded, fixed with bolts, or mounted in some other manner at each end of guide rails 16. Each guide rail 16 further includes a pair of downwardly depending tab members 20 adapted for receipt in any one of a number of matching slot 22 formed in base rails 14. A connecting pin 24 is then passed through aligned, cooperating apertures in each of the base rails 14 and tab members 20 to retain guide rails 16 in position. A clevis pin or other means 26 may then be utilized to secure each connecting pin 24.

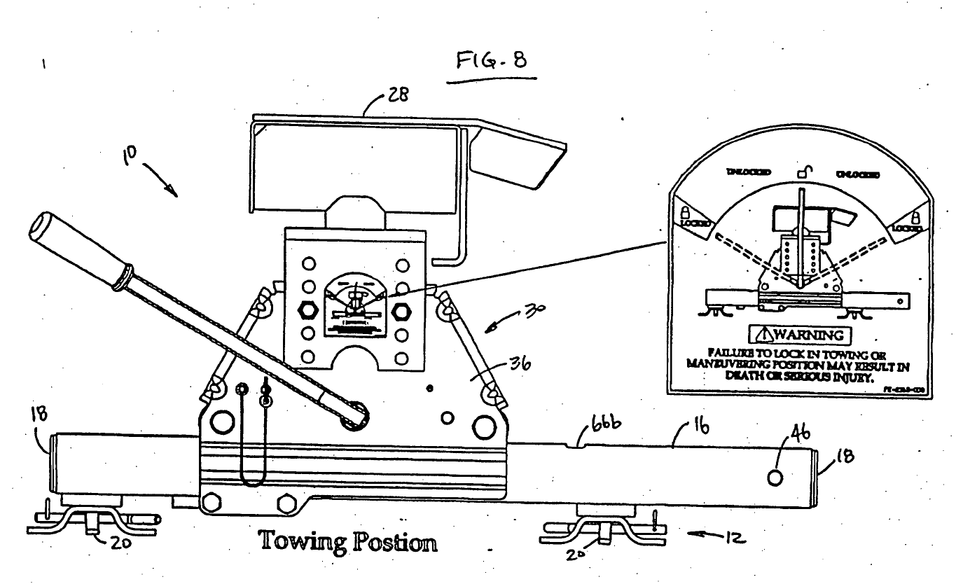

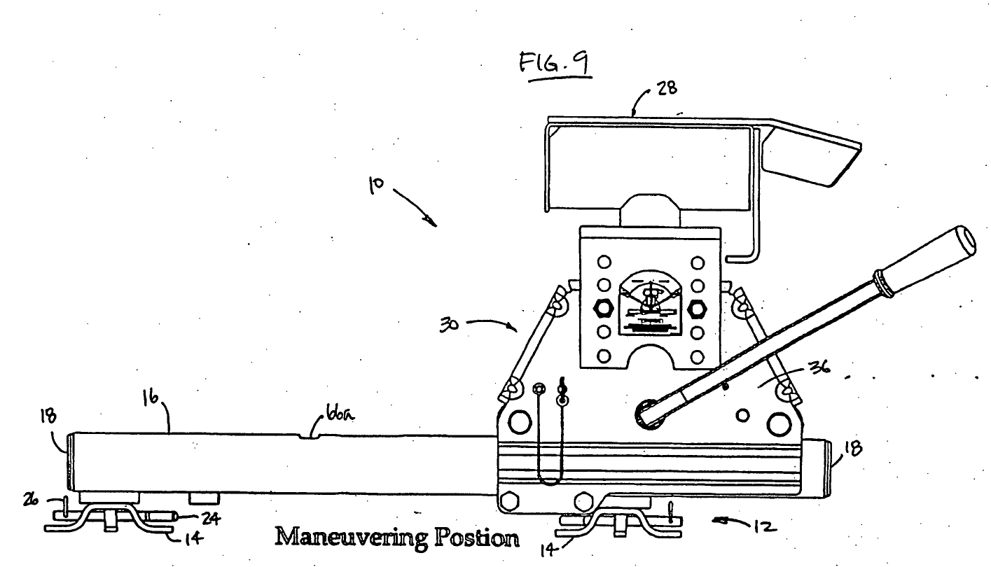

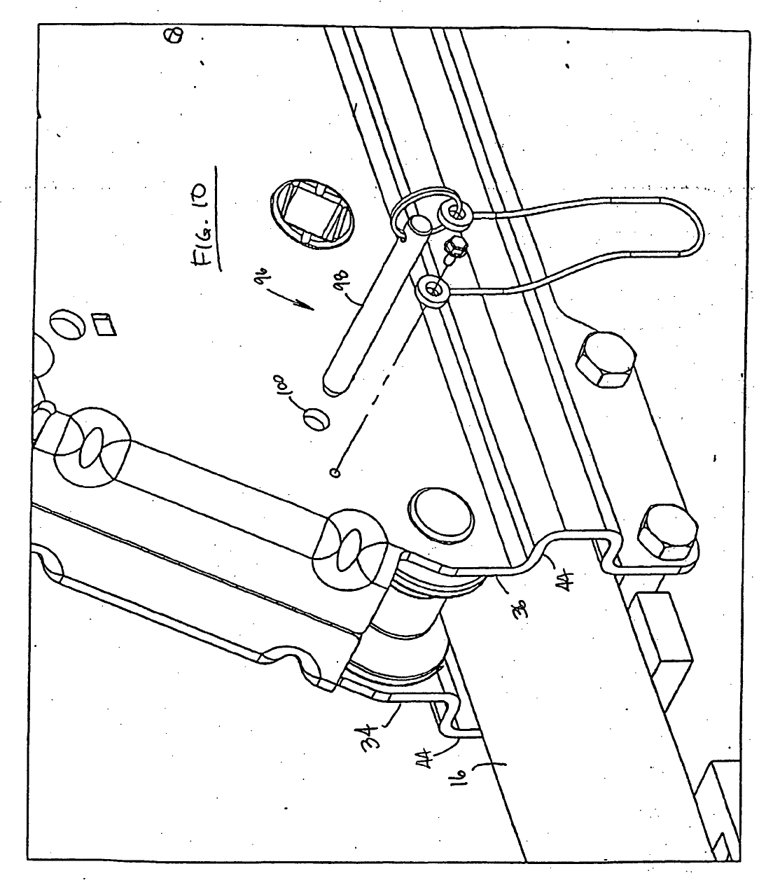

As is known in the art, fifth wheel hitch 10 also includes a head assembly 28 (FIGS. 8 and 9) having a jaw assembly (not shown) for releasably engaging the kingpin of a trailer to be towed by the motor vehicle equipped with fifth wheel hitch 10. Such jaw assemblies are well known in the art and, thus, in the interest of brevity will not be discussed in detail herein.

Fifth wheel hitch 10 further includes a pair of adjustment assemblies 30 for carrying the head assembly on the pair of spaced guide rails 16 so that the head assembly is selectively displaceable between a towing position for properly distributing the weight of the trailer for high speed over-the-road towing and a maneuvering position for providing added clearance between the body work of the towing vehicle and the trailer. This additional clearance between the bodywork of the motor vehicle and the trailer provides the necessary space to allow the operator to negotiate tight corners without the trailer binding or otherwise damaging the towing vehicle. Hence, greater maneuverability is provided for vehicle operation in confined areas such as are often encountered in parking lots, trailer parks, campgrounds, and the like.

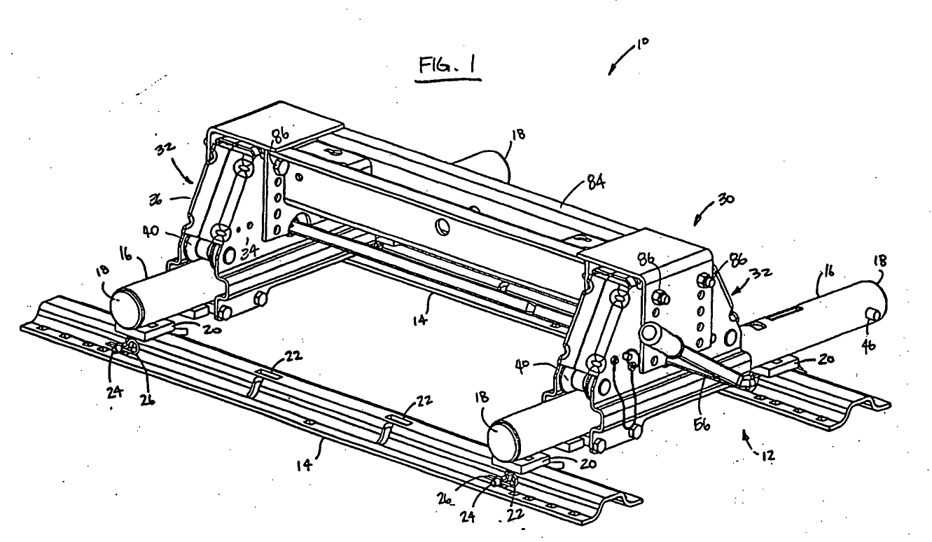

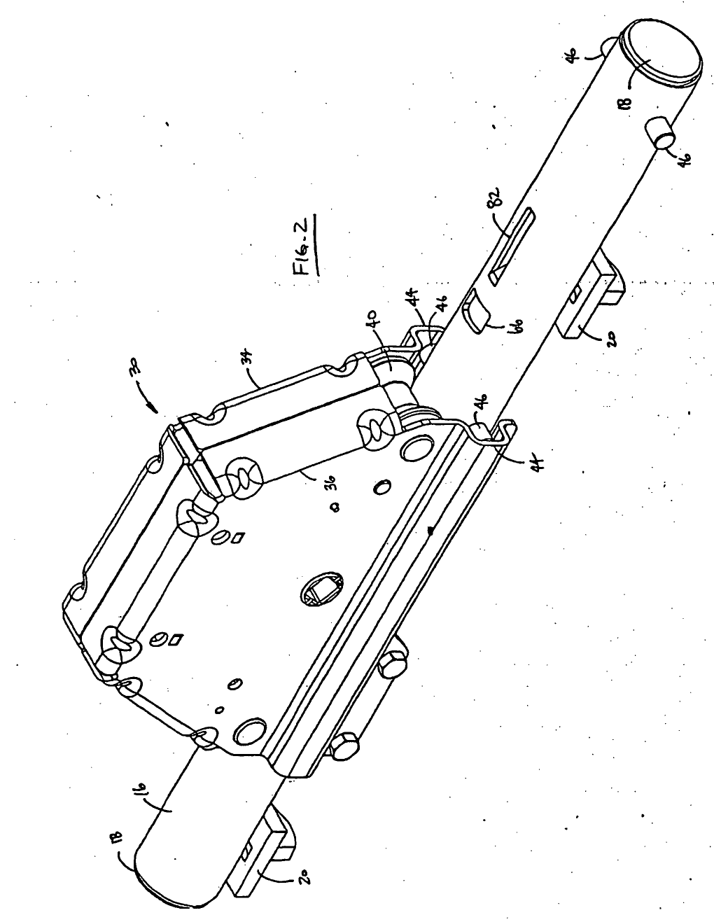

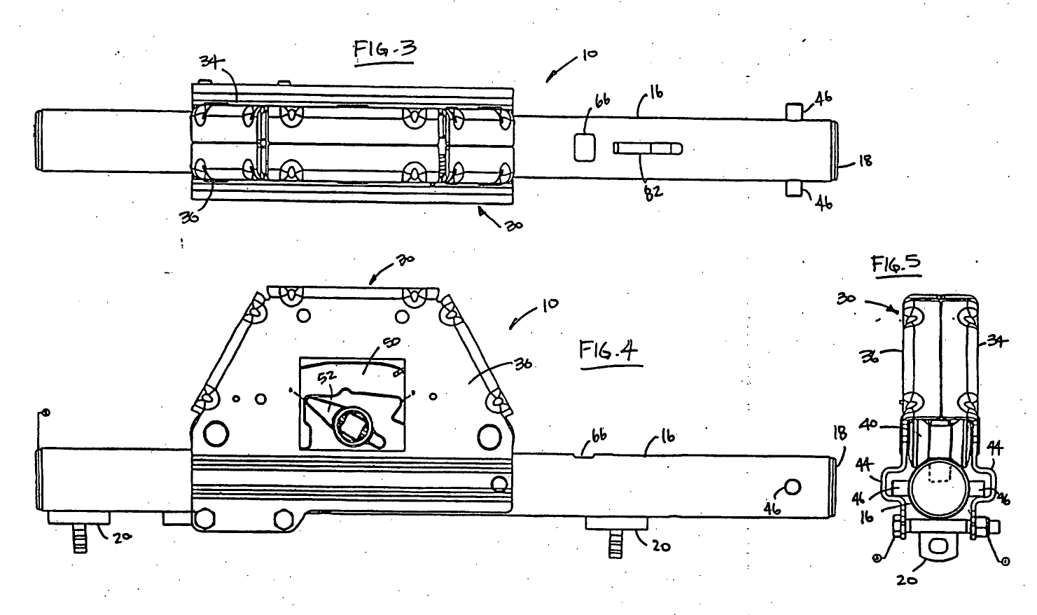

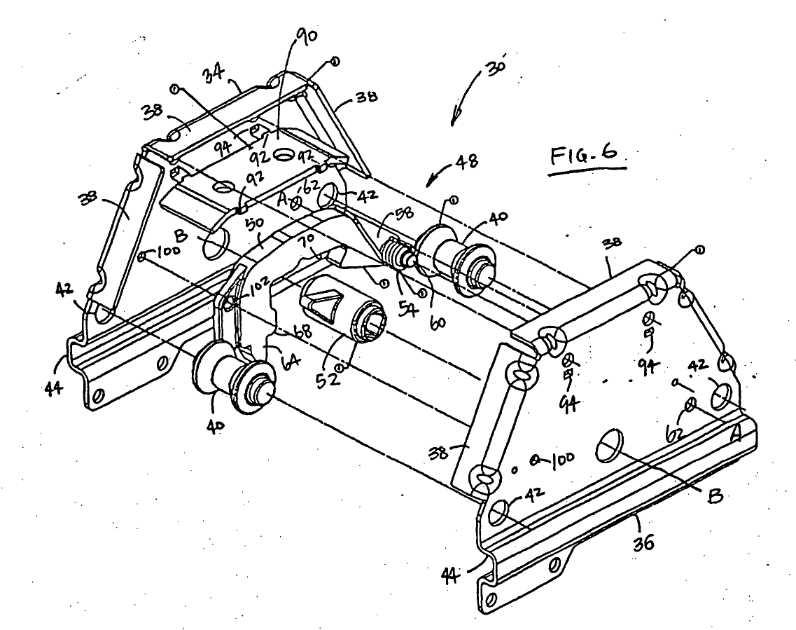

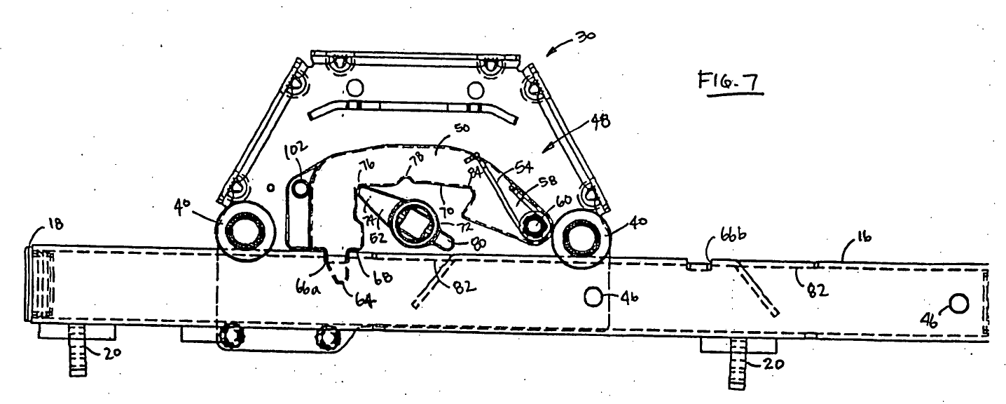

As can be seen in FIGS. 1-7, adjustment assemblies 30 are generally identical in construction and, thus, only one of the pair will be described in detail. Adjustment assembly 30 generally includes an inboard plate 34 and an outboard plate 36. Inboard plate 34 and outboard plate 36 generally include a plurality of flanges 38 formed along the upper periphery thereof, which are adapted to generally abut together to define a volume therein. As best seen in FIG. 6, each of the pair of adjustment assemblies 30 includes a pair of rollers 40 rotatably supported by a pair of aligned apertures 42 formed in inboard plate 34 and outboard plate 36. As can be seen in FIGS. 2 and 5, rollers 40 are generally V-shaped and are adapted to rollably engage guide rail 16 to provide non-binding movement of head assembly 28 relative to support frame 12. It should be understood that unlike conventional designs that have relied upon the use of four-side tubular members, the present invention employs tubular members having round or otherwise oblong cross sections. This has been determined to eliminate, or at least minimize, any bind between adjustment assembly 30 and guide rail 16. Additionally, the use of round or otherwise oblong shaped guide rails and rollers provides a more dependable and slidable arrangement than the use of square shaped rails and low friction shoes as used in the prior art. Still further, it should be understood that the use of round or otherwise oblong shaped guide rails and rollers provides a system that is capable of self-aligning and tracking during movement.

In order to further prevent or at least minimize any binding effect caused by the movement of head assembly 28 relative to support frame 12, fifth wheel hitch 10 according to the principles of the present invention further employs a pair of guide channels 44 formed along inboard plate 34 and outboard plate 36, generally adjacent and parallel to a plurality of guide studs 46 extending from guide rail 16. The cooperation of the pair of guide channels 44 and the plurality of guide studs 46 resists torsional forces exerted upon head assembly 28 and/or adjustment assembly 30.

Referring now to FIGS. 1, 6, and 7, adjustment assembly 30 further includes a locking assembly 48, which is adapted to releasably secure adjustment assembly 30 relative to guide rail 16 to prevent relative movement of head assembly 28 and support frame 12. Locking assembly 48 employs a locking arm engagable with slots formed in guide 16, which resist such relative movement when in a locked position. More particularly, as seen in FIGS. 1 and 6, locking assembly 48 includes a locking arm 50, a locking cam 52, a lock spring 54, and an actuating handle 56. Locking arm 50 generally includes a base portion 58 having a pair of pivot studs 60 extending therefrom. The pair of pivot studs 60 are sized to engage a pair of aligned apertures 62 formed in inboard plate 34 and outboard plate 36 to permit locking arm 50 to pivot about axis A.

Opposite base portion 58, locking arm 50 further includes a head portion 64, which is sized to engage a number of locking slots 66 formed in guide rail 16. It should be understood that the positioning of locking slots 66 along guide rail 16 determines the range of adjustability between a towing position, where the trailering load is positioned generally forward of or over a drive axle of the towing vehicle, and a maneuvering position, where the trailering load is positioned generally behind the drive axle of the towing vehicle. It is anticipated that additional locking slots may be provided to provide additional adjustability. Locking arm 50 still further includes a shoulder portion 68 that is sized larger than locking slots 66. Shoulder portion 68 engages an area on guide rail 16 adjacent locking slot 66, thereby limiting the depth of engagement of head portion 64 of locking arm 50 and locking slot 66.

Locking arm 50 still further includes a cam surface 70 formed along an underside thereof. Cam surface 70 is contoured to cooperate with locking cam 52 to raise and lower head portion 64 relative to guide rail 16. As best seen in FIG. 6, locking cam 52 generally includes a main cylindrical body 72 and a finger 74 extending from body 72. Locking cam 52 is fixedly coupled with actuating handle 56 such that pivotal movement of actuating handle 56 about an axis B causes locking cam 52 to similarly pivot, thereby driving finger 74 into engagement with cam surface 70 formed on locking arm 50.

As seen in FIGS. 6 and 7, locking arm 50 can be positioned in either 1) a lowered and locked position where head portion 64 engages locking slot 66 and shoulder portion 68 rests upon guide rail 16 or 2) in a raised and unlocked where head portion 64 is raised out of locking slot 66. Such movement of locking arm 50 between the lowered and locked position and the raised and unlocked position is accomplished through a simple auto-engaging operation. That is, as best seen in FIGS. 7-9, during operation adjustment assembly 30 and head assembly 28 is moved relative to support frame 12 between a towing position (FIGS. 7 and 8) and a maneuvering position (FIG. 9). When adjustment assembly 30 is in the lowered and locked position in the towing position (FIGS. 7 and 8), head portion 64 of locking arm 50 engages a forward locking slot 66a and finger 74 of locking cam 52 is received within a first notch 76 formed in cam surface 70. Preferably, finger 74 does not contact first notch 76, thereby enabling head portion 64 of locking arm 50 to be fully received within locking slot 66a. In this position, lock spring 54 acts upon locking arm 50 to bias locking arm 50 into engagement with locking slot 66.

In order to position head assembly 28 and adjustment assembly 30 into the maneuvering position (FIG. 9), an operator rotates actuating handle 56 from a generally forward slanted position (FIG. 8) into a generally vertical position. The rotation of actuating handle 56 into a generally vertical position drives locking cam 52 such that finger 74 cams along cam surface from first notch 76 to a center detent 78, which causes locking arm 50 to pivot about axis A into the raised and unlocked position (where head portion 64 is removed from engagement with locking slot 66a). In this position, finger 74 is retained in position within detent 78. However, as can be seen in FIG. 7, locking cam 52 includes a tab 80 opposite finger 74. Tab 80 is sized so as to be received within a tab slot 82 formed in guide rail 16 (FIGS. 2 and 7). As should be appreciated, in this position, adjustment assembly 30 and head assembly 28 are free to slide relative to support frame 12.

As adjustment assembly 30 and head assembly 28 are slid rearward toward the maneuvering position (FIG. 9), tab 80 of locking cam 52 engages a rearward edge of tab slot 82. As adjustment assembly 30 continues to slid rearward, the engagement of tab 80 with the rearward edge of tab slot 82 causes locking cam 52 to rotate about axis B (clockwise in FIG. 7) such that finger 74 exits detent 78 and travels along cam surface 70. The downward biasing force on locking arm 50 causes locking cam 52 to further pivot until finger 74 of locking cam 52 is generally received within a second notch 84. Preferably, finger 74 does not contact second notch 84. However, during this operating, head portion 64, in response to the biasing force of lock spring 54, engages the outer surface of guide rail 16. Head portion 64 of locking arm 50 will continue to ride along the outer surface of guide rail 16 as adjustment assembly 30 is slid rearward into the maneuvering position until head portion 64 finds locking slot 66b. Once head portion 64 is positioned generally over locking slot 66b, the biasing force of locking spring 54 forces head portion 64 into locking engagement with locking slot 66b, thereby creating a positive engagement therebetween. Moreover, the driving of the head portion 64 into locking engagement with locking slot 66b may provide an audible signal that proper engagement has been achieved.

A similar operation is used to position head assembly 28 and adjustment assembly 30 back into the towing position—actuating handle 56 is pivoted into a generally vertical position, finger 74 is positioned into detent 78, tab 80 is received within tab slot 82, locking arm 50 is raised and unlocked, and forward movement of adjustment assembly 30 relative to support frame 12 causes tab 80 to engage a forward edge of tab slot 82, thereby rotating locking cam 52 (counterclockwise in FIG. 7) until finger 74 is positioned into first notch 76, and head portion 64 rides along the outer surface of guide rail 16. However, it should be appreciated that as head portion 64 approaches the forward tab slot 82, head portion 64 will continue to slide over forward tab slot 82 due to the larger width of head portion 64 relative tab slot 82. Once head portion 64 is positioned generally over locking slot 66a, the biasing force of locking spring 54 forces head portion 64 into locking engagement with locking slot 66a, thereby creating a positive engagement therebetween.

Referring again to FIG. 1, a cross member or head support 84 bridges between and interconnects the adjustment assemblies 30. Preferably, head support 84 is height adjustable to enhance the versatility of fifth wheel hitch 10 in interconnecting motor vehicles and trailers of various height dimensions. As can be seen in FIG. 1, head support 84 is coupled to adjustment assemblies 30 via a plurality of fasteners 86. Fasteners 86 are preferably used to further couple upper portions of inboard plate 34 and outboard plate 36 together. A separate pair of fasteners 88 are also provided to couple lower portions of inboard plate 34 and outboard plate 36 together. To counteract the clamping forces exerted upon adjustment assembly 30 by fasteners 86, a support bracket 90 is disposed between inboard plate 34 and outboard plate 36 generally adjacent fasteners 86. Support bracket 90 includes a plurality of tabs 92 extending therefrom to cooperate with slots 94 formed in inboard plate 34 and outboard plate 36.

Referring now to FIGS. 1, 6, and 10, a locking arm retaining device 96 is employed so as to provide additional safety. In prior art adjustable hitches, it has been seen that these designs may be easily unlocked so as to permit the head assembly to slide relative to the support frame. However, if the driver is not aware that the hitch assembly has been unlocked, the initial acceleration of the towing vehicle will cause the trailer to pull the hitch rearward against any physical stops. This often causes a large impact force against the towing vehicle and the trailer. The natural reaction of the driver is to slam on the brakes, which then causes the trailer to slide forward against the forward physical stops causes another large impact force against the towing vehicle and trailer. In an attempted to prevent this situation, locking arm retaining device 96 ensures that locking arm 50 may not be raised and unlocked from engagement with guide rail 16 until locking arm retaining device 96 is removed. Locking arm retaining device 96 includes a locking pin 98 that extends through a pair aligned apertures 100 formed in inboard plate 34 and outboard plate 36 and an aperture 102 formed in locking arm 50. Such arrangement prevents locking arm 50 from being unintentionally pivoted out of engagement with guide rail 16. A clevis pin or other suitable fastener may be used to ensure locking pin 98 cannot inadvertently be removed. It is anticipated that a padlock may be used to secure locking pin 98, which would prevent any unauthorized actuation of locking assembly 48.

The description of the invention is merely exemplary in nature and, thus, variations that do not depart from the gist of the invention are intended to be within the scope of the invention. Such variations are not to be regarded as a departure from the spirit and scope of the invention.

1. An adjustable fifth wheel hitch for towing a trailer behind a motor vehicle, comprising:
a support frame having a pair of guide rails;
a head assembly;
an adjustment assembly coupling said head assembly to said pair of guide rails so as to be selectively displaceable between a towing position and a maneuvering position; and
a locking assembly for releasably locking said head assembly in said towing and maneuvering positions, said locking assembly having a locking arm positionable in a locked position and an unlocked position, said locking arm having a camming surface; and
a locking cam cammingly engaging said camming surface on said locking arm so as to position said locking arm in said locked position and said unlocked position.

2. The adjustable fifth wheel hitch according to claim 1 wherein said pair of spaced guide rails are generally round in cross section.

3. The adjustable fifth wheel hitch according to claim 1, further comprising: a retaining device selectively engaging said locking arm so as to prohibit unintentional movement of said locking arm from said locked position to said unlocked position.

4. The adjustable fifth wheel hitch according to claim 1, further comprising:
a guide stud extending from at least one of said pair of spaced guide rails;
an inboard plate;
an outboard plate coupled to said inboard plate generally adjacent to said at least one of said pair of guide rails, said inboard plate and said outboard plate generally supporting said locking assembly, at least one of said inboard plate and said outboard having a guide channel formed therein, said guide channel being sized to receive said guide stud to generally maintain sliding alignment.

5. An adjustable fifth wheel hitch comprising:
a guide rail;
a head assembly;
an adjustment assembly mounted to the guide rail and carrying said head assembly, wherein said head assembly is selectively displaceable between a towing position and a maneuvering position; and
a locking assembly connected with said adjustment assembly for releasably locking said head assembly in said towing and maneuvering positions.

6. The adjustable fifth wheel hitch of claim 5, wherein said adjustment assembly comprises:
an inboard plate;
an outboard plate;
a roller supported by said inboard and outboard plates and rollably engageable with said guide rail and capable of providing substantially non-binding movement of said head assembly relative to said support frame.

7. The adjustable fifth wheel hitch of claim 6, wherein said locking assembly comprises a locking arm positionable in a locked position wherein said locking arm engages said guide rail and an unlocked position wherein said locking arm disengages from said guide rail.

8. The adjustable fifth wheel hitch of claim 7, wherein said locking arm further comprises a camming surface.

9. The adjustable fifth wheel hitch of claim 8, further comprising a locking cam cammingly engaging said camming surface on said locking arm to position said locking arm in said locked position and said unlocked position.

10. The adjustable fifth wheel hitch of claim 9, further comprising a second guide rail spaced from said guide rail.

11. The adjustable fifth wheel hitch of claim 9, wherein said guide rail has a generally round cross section.

12. The adjustable fifth wheel hitch of claim 9, wherein said guide rail has a generally oval cross section.

13. The adjustable fifth wheel hitch of claim 9, further comprising a retaining device selectively engaging said locking arm to prohibit unintentional movement of said lock arm from said locked position to said unlocked position.

14. The adjustable fifth wheel hitch of claim 13, further comprising a guide stud extending from the guide rail.

15. The adjustable fifth wheel hitch of claim 14, wherein said guide channel is sized to receive said guide stud to generally maintain sliding alignment.

16. An adjustable fifth wheel hitch comprising:
a support frame having a guide rail;
a head assembly; and
an adjustment assembly mounted to said guide rail and carrying said head assembly wherein said adjustment assembly comprises:
an inboard plate;
an outboard plate; and
a roller supported by said inboard and outboard plates and rollably engageable with said guide rail capable of providing substantially non-binding movement of said head assembly relative to said support frame and permitting
said head assembly to be selectively displaceable between a towing position and a maneuvering position.

17. The adjustable fifth wheel hitch assembly of claim 16 further comprising a pair of guide channels formed along said inboard and outboard plates.

18. The adjustable fifth wheel hitch assembly of claim 17 further comprising a plurality of guide studs extending from said guide rail and being adjacent and parallel to said guide channels.

19. The adjustable fifth wheel hitch assembly of claim 18 wherein cooperation of said guide channels and said guide studs resists torsional forces exerted upon at least one of said head assembly and adjustment assembly.

20. The adjustable fifth wheel hitch assembly of claim 19, further including a handle wherein rotating said handle selectively displaces said head assembly between a towing position and a maneuvering position.
